(19) United States
(12) Patent Application Publication
(10) Pub. No.: US 2024/0007340 A1
(43) Pub. Date: Jan. 4, 2024

(54) EXECUTING ON-DEMAND WORKLOADS INITIATED FROM CLOUD SERVICES IN A SOFTWARE-DEFINED DATA CENTER

(71) Applicant: VMware, Inc., Palo Alto, CA (US)

(72) Inventors: Prateek GUPTA, San Francisco, CA (US); Fnu YASHU, Sunnyvale, CA (US); John E. BREZAK, Camano Island, WA (US); Mathangi VENKATESAN, Cupertino, CA (US)

(21) Appl. No.: 17/853,806

(22) Filed: Jun. 29, 2022

(51) Int. Cl. H04L 41/046; H04L 67/10

(52) U.S. Cl. CPC H04L 41/046; G06F 9/546; H04L 67/10

(57) ABSTRACT

A method of executing a workload initiated from a cloud platform, in a software-defined data center (SDDC), wherein the cloud platform delivers cloud services to the SDDC, includes the steps of: deploying a first agent in an agent appliance platform that is connected to a management network of the SDDC, wherein the first agent is an agent of one of the cloud services and issues commands to execute the workload on the SDDC; and upon completion of the workload, deleting the first agent from the agent appliance platform.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network, through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services” are delivered to the SDDCs through agents of the cloud services that are running in an appliance (referred to herein as an “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the agent platform appliance, for example, through respective agents of the cloud services that are deployed on the agent platform appliance.

One or more embodiments provide a method of executing a workload initiated from a cloud platform, in an SDDC, wherein the cloud platform delivers cloud services to the SDDC. The method includes the steps of: deploying a first agent in an agent appliance platform that is connected to a management network of the SDDC, wherein the first agent is an agent of one of the cloud services and issues commands to execute the workload on the SDDC; and upon completion of the workload, deleting the first agent from the agent appliance platform.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a computer system in which embodiments may be implemented.

FIG. 2 is a flow diagram of steps performed by a group of agents of an agent appliance platform and a cloud authentication service to carry out a method of acquiring an access token for authenticating with a message broker service of a cloud platform, according to an embodiment.

FIG. 3 is a flow diagram of steps performed by a group of agents of the agent appliance platform to carry out a method of deploying an instance of an on-demand agent that issues commands to execute a workload on an SDDC, according to an embodiment.

FIG. 4 is a flow diagram of steps performed by a group of agents of the agent appliance platform to carry out a method of issuing commands to a component of the SDDC and detecting results of the performance of a workload, according to an embodiment.

FIG. 5 is a sequence diagram illustrating an example of an agent of the agent appliance platform generating an alert indicating that an SDDC requires remediation, and in response, a cloud service of the cloud platform generating a message to initiate remediation.

### DETAILED DESCRIPTION

Techniques for executing workloads initiated by cloud services of a cloud platform are described. According to embodiments, an agent appliance platform is deployed in a customer environment of a tenant, the customer environment including one or more SDDCs with management software for the SDDCs executing therein.

To initiate the workloads, agents of the cloud services are deployed in the agent appliance platform. Some of the agents, referred to herein as “persistent agents,” execute in the agent appliance platform indefinitely once deployed. Other agents, referred to herein as “on-demand agents,” only execute in the agent appliance platform for limited times. Once deployed, the on-demand agents download executable scripts from which the on-demand agents issue commands to the SDDCs to execute workloads. Commands issued by the on-demand agents may include, e.g., remediation operations for remediating the management software of the SDDCs to desired states and mutation operations for modifying virtual inventories of virtual objects deployed in the SDDCs such as VMs. Upon completion of the workloads, a coordinator agent deployed in the agent appliance platform deletes the on-demand agents. In some embodiments, some on-demand agents have executable images already loaded in the agent appliance platform, such that they can execute the workloads when they are deployed without having to download executable scripts.

The deployment of on-demand agents that are deleted upon completion of workloads offers various advantages. For example, cloud services are able to run workloads via the on-demand agents without intervention by the tenant of the SDDCs. The on-demand agents then gracefully exit such that the coordinator agent no longer manages the on-demand agents, thus enabling the coordinator agent to execute other tasks efficiently. These and further aspects of the invention are discussed below with respect to the drawings.

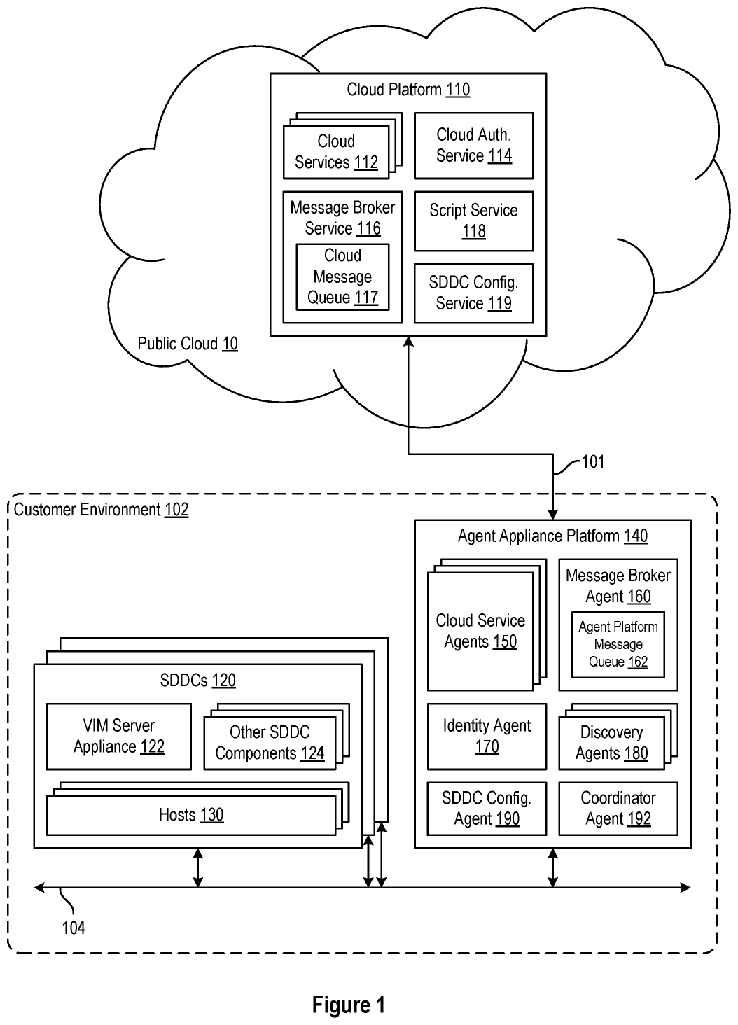

FIG. 1 is a block diagram of a computer system in which embodiments may be implemented. The computer system includes a multi-tenant cloud platform 110 deployed in a public cloud 10, and a customer environment 102 in which SDDCs 120 of a particular tenant are deployed. Communications between cloud platform 110 and SDDCs 120 are carried out via an agent appliance platform 140 of customer environment 102. Communications between cloud platform 110 and agent appliance platform 140 are carried out over a public network 101 such as the Internet.

Each of SDDCs 120 includes hosts 130, hosts 130 being constructed on server grade hardware platforms (not shown) such as x86 architecture platforms. Hosts 130 include conventional components of computing devices (not shown), such as one or more central processing units (CPUs), memory such as random-access memory (RAM), local storage such as one or more magnetic drives or solid-state drives (SSDs) and/or a host bus adapter for connection to a storage area network, and one or more network interface cards (NICs). The NIC(s) enable hosts 130 to communicate with each other and with other devices over a management network 104. Hosts 130 include software platforms including hypervisors (not shown), which are virtualization software layers that support VM execution spaces (not shown) within which VMs are concurrently instantiated and executed. Each of SDDCs 120 also includes additional hardware devices (not shown) such as shared storage and networking devices.

Each of SDDCs 120 includes a VIM server appliance 122 and other SDDC components 124 each running various management software. VIM server appliance 122 logically groups hosts 130 into a cluster to perform cluster-level tasks such as provisioning and managing VMs and migrating VMs from one host 130 to another. One example of VIM server appliance 122 is a VMware vCenter Server® appliance from VMware, Inc. Other SDDC components 124 provide other management functionalities such as provisioning virtual networking resources. An example of one of other SDDC components 124 is a VMware NSX® appliance from VMware, Inc.

VIM server appliance 122 and other SDDC components 124 communicate via management network 104, and the various management software running thereon are referred to collectively herein as “management software.” Management network 104 is distinguishable from public network 101 in that it is a private network, e.g., a local area network or a sub-net, and is partitioned from public network 101 through a firewall. In some embodiments, each of the SDDC components including VIM server appliance 122 is a VM instantiated on one or more of hosts 130. In other embodiments, each of the SDDC components may be implemented as a physical host having the conventional hardware platform described above with respect to hosts 130.

Cloud platform 110 is provisioned in public cloud 10, and public cloud 10 is operated by a cloud computing service provider from a plurality of physical host computers (not shown). Cloud platform 110 includes cloud services 112, a cloud authentication service 114, a message broker service 116, a script service 118, and an SDDC configuration service 119. Cloud services 112 include an SDDC upgrade service, an SDDC monitoring service, and an SDDC inventory service. Message broker service 116 provides a method of communicating securely with cloud platform 110, as discussed further below.

Cloud authentication service 114 enables authentication with message broker service 116. To enable such authentication, cloud authentication service 114 issues access tokens such as JavaScript Object Notation (JSON) web tokens (JWTs). Each access token allows a requesting party to interface with cloud platform 110 through message broker service 116, as discussed below. It should be noted that although cloud authentication service 114 is illustrated as being within cloud platform 110, cloud authentication service 114 may run on a virtual or physical server that is not a part of cloud platform 110. For security purposes, access tokens each have a specified time-to-live (TTL), after which the tokens expire.

Script service 118 manages executable scripts (not shown) for cloud services 112, the executable scripts including workloads for execution by on-demand agents. SDDC configuration service 119 manages one or more desired states of SDDCs 120. When there is drift between a desired state of one of SDDCs 120 and an active running state thereof, SDDC configuration service 119 initiates a workload to remediate SDDC 120 back to its corresponding desired state.

Agent appliance platform 140 is, e.g., a physical server, or a VM deployed on a host similar to hosts 130, the host including a CPU(s) configured to execute instructions such as executable instructions that perform one or more operations described herein and including memory in which such executable instructions are stored. Agent appliance platform 140 is also connected to management network 104 such that agent appliance platform 140 and SDDCs 120 are on the same side of a firewall (not shown) of customer environment 102. As a result, communications between agent appliance platform 140 and SDDCs 120 are secure and protected from attacks originating from outside customer environment 102 such as snooping attacks.

On agent appliance platform 140, various agents are deployed, including cloud service agents 150, a message broker agent 160, an identity agent 170, discovery agents 180, an SDDC configuration agent 190, and a coordinator agent 192. The agents on agent appliance platform 140 communicate with each other, e.g., through hypertext transfer protocol (HTTP) APIs. The agents on agent appliance platform 140 also communicate with SDDCs 120 and cloud platform 110, as discussed further below.

Cloud service agents 150, which correspond to cloud services 112, issue commands to the management software of SDDCs 120 and report results of operations to cloud services 112. Furthermore, message broker agent 160 provides a method through which cloud service agents 150 communicate with cloud services 112. Cloud service agents 150 transmit messages to message broker agent 160, referred to herein as “agent-to-cloud” messages. Each agent-to-cloud message includes the name of one of cloud services 112, which is the intended recipient. Message broker agent 160 temporarily stores agent-to-cloud messages in an agent platform message queue 162.

Similarly, cloud services 112 transmit messages to message broker service 116. Each message from one of cloud services 112, referred to herein as a “cloud-to-agent” message, may include the name of one of cloud service agents 150 as the intended recipient. Message broker service 116 temporarily stores cloud-to-agent messages in queues corresponding to various tenants, including a cloud message queue 117 corresponding to the tenant of SDDCs 120.

To provide agent-to-cloud messages to cloud services 112 and cloud-to-agent messages to cloud service agents 150, message broker service 116 and message broker agent 160 exchanges messages, e.g., periodically. Specifically, message broker agent 160 initiates the exchange with message broker service 116. Message broker agent 160 transmits agent-to-cloud messages to message broker service 116, which forwards them to cloud services 112. In exchange, message broker service 116 transmits cloud-to-agent messages to message broker agent 160, which forwards them to cloud service agents 150.

Identity agent 170 is deployed on agent appliance platform 140 to acquire access tokens from cloud authentication service 114. Identity agent 170, when deployed, is given access to a private key of the tenant (not shown) and transmits a challenge phrase that is signed with the private key as payload for authenticating with cloud authentication service 114. In response, cloud authentication service 114 decrypts the payload using a public key of the tenant (not shown) and issues an access token for the tenant if the decrypted payload matches the challenge phrase. The access token enables message broker agent 160 to authenticate with cloud platform 110.

Discovery agents 180 are deployed on agent appliance platform 140 to manage communication with the management software of SDDCs 120. Each of discovery agents 180 corresponds to one type of management software for all of SDDCs 120. For example, one discovery agent is deployed for VIM server appliances 122 of all of SDDCs 120, and other discovery agents are deployed respectively for other SDDC components 124 of all of SDDCs 120. Each of discovery agents 180 communicates with its respective SDDC components, such as VIM server appliance 122, to acquire authentication tokens. The authentication tokens are used by cloud service agents 150 to authenticate communications with the management software.

SDDC configuration agent 190, which corresponds to SDDC configuration service 119, monitors the running states of SDDCs 120, e.g., periodically. Through its monitoring, SDDC configuration agent 190 detects events associated with SDDCs 120 such as “drift events” in which the running state of an SDDC is out of compliance with its corresponding desired state. Upon detecting such events, SDDC configuration agent 190 transmits a message to message broker agent 160 indicating the event. Similarly to messages received from cloud service agents 150, message broker agent 160 transmits the message to message broker service 116 in a message exchange, and message broker service 116 provides the message to SDDC configuration service 119.

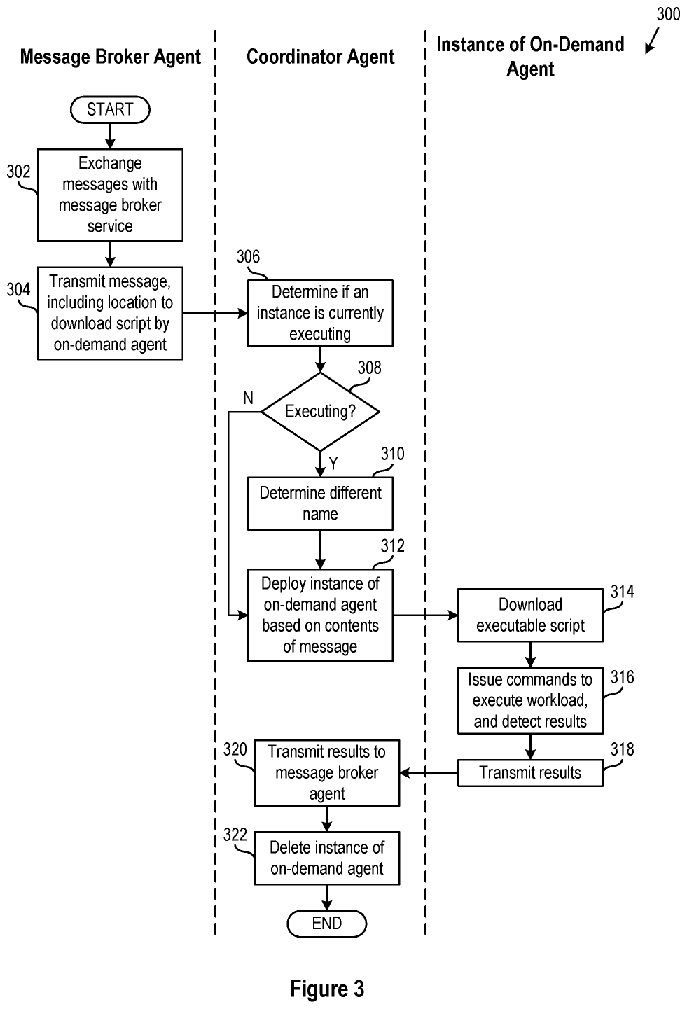

Coordinator agent 192 deploys cloud service agents 150, some of cloud service agents 150 being persistent agents and other of cloud service agents 150 being on-demand agents. Coordinator agent 192 deploys persistent agents upon the deployment of agent appliance platform 140, the persistent agents continuing to execute on behalf of corresponding cloud services 112 indefinitely. Furthermore, cloud services 112 transmit messages to coordinator agent 192 via message broker service 116 and message broker agent 160 to deploy on-demand agents. In response, coordinator agent 192 deploys the on-demand agents, which download executable scripts from script service 118 via message broker agent 160 and message broker service 116. The on-demand agents then issue commands to execute workloads on SDDCs 120 before being deleted upon completion of the workloads, as discussed further below in conjunction with FIG. 3.

In one embodiment, each of the cloud services is a microservice that is implemented as one or more container images executed on a virtual infrastructure of public cloud 10. Similarly, each of the agents deployed on agent appliance platform 140 is a microservice that is implemented as one or more container images executing in agent appliance platform 140.

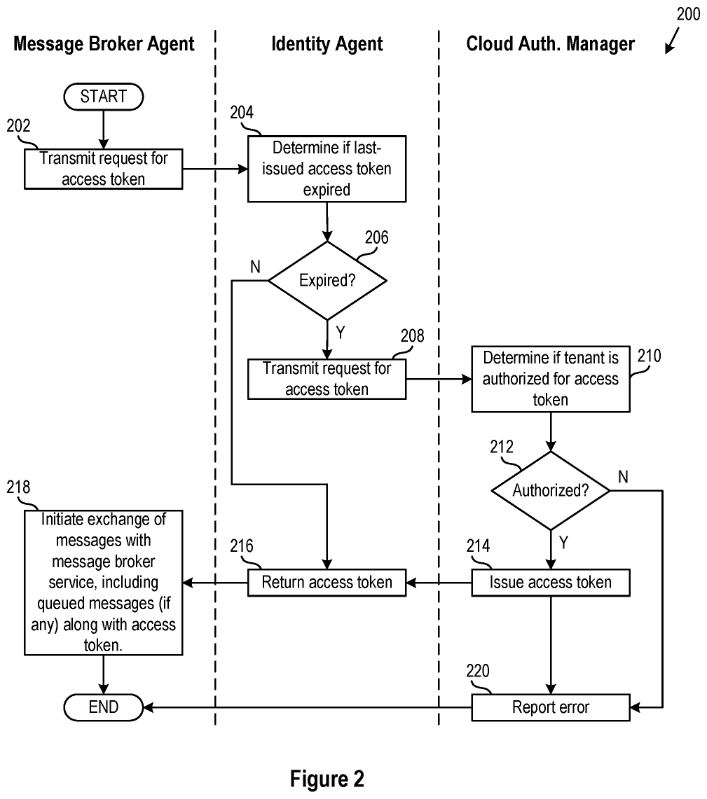

FIG. 2 is a flow diagram of steps performed by message broker agent 160, identity agent 170, and cloud authentication service 114 to carry out a method 200 of acquiring an access token for authenticating with message broker service 116, according to an embodiment. At step 202, message broker agent 160 transmits a request to identity agent 170 for an access token. At step 204, identity agent 170 determines if the last access token (if any) acquired by identity agent 170 is expired, i.e., if the TTL thereof has lapsed. At step 206, if the last-issued access token is still active, method 200 moves to step 216. Otherwise, if the last-issued access token has expired (or if identity agent 170 has not yet acquired an access token), method 200 moves to step 208.

At step 208, identity agent 170 transmits a request to cloud authentication service 114 for a new access token, the request including a payload containing the challenge phrase that is digitally signed using the private key of the tenant, as described above. At step 210, cloud authentication service 114 determines if the tenant is authorized for an access token by decrypting the payload in the request using the public key of the tenant and confirming the challenge phrase in the manner described above. At step 212, if the tenant is authorized, method 200 moves to step 214, and cloud authentication service 114 issues a new access token to identity agent 170. At step 216, identity agent 170 returns an access token to message broker agent 160, the access token being either a previously issued access token determined to be active at step 206 or an access token issued at step 214.

At step 218, message broker agent 160 initiates an exchange of messages with message broker service 116. Specifically, message broker agent 160 transmits queued messages from agent platform message queue 162 (if any) to message broker service 116, along with the access token. After step 218, method 200 ends, and message broker service 116 provides the agent-to-cloud messages (if any) to cloud services 112 identified in the messages. Returning to step 212, if the tenant is not authorized, method 200 moves to step 220. At step 220, cloud authentication service 114 reports an error, notifying identity agent 170 that the new access token cannot be issued. After step 220, method 200 ends.

FIG. 3 is a flow diagram of steps performed by message broker agent 160 and coordinator agent 192 to carry out a method 300 of deploying an instance of an on-demand agent that issues commands to execute a workload on one of SDDCs 120, according to an embodiment. At step 302, message broker agent 160 exchanges messages with message broker service 116 as discussed above, message broker agent 160 transmitting one or more agent-to-cloud messages from agent platform message queue 162 to message broker service 116 in exchange for a cloud-to-agent message from cloud message queue 117. The cloud-to-agent message originated from one of cloud services 112 or SDDC configuration service 119 and identifies coordinator agent 192 as its intended recipient. For example, the cloud-to-agent message may have been generated in response to an alert from SDDC configuration agent 190 requesting remediation due to drift.

At step 304, message broker agent 160 transmits the cloud-to-agent message to coordinator agent 192. The cloud-to-agent message includes an instruction to deploy an on-demand cloud agent and a location such as a uniform resource locator (URL) from which to download an executable script from script service 118. At step 306, coordinator agent 192 determines if an instance of the on-demand agent is currently executing for corresponding cloud service 112 or SDDC configuration service 119. At step 308, if no instance of the on-demand agent is currently executing, method 300 moves to step 312. Otherwise, if an instance of the on-demand agent is currently executing, method 300 moves to step 310.

At step 310, coordinator agent 192 determines a different name for a new instance of the on-demand agent. For example, if the on-demand agent corresponds to SDDC configuration service 119 and an instance of the on-demand agent named “remediation agent 1” is currently executing, coordinator agent 192 determines a different name such as “remediation agent 2.” At step 312, coordinator agent 192 deploys a new instance of the on-demand agent based on the contents of the cloud-to-agent message, including communicating to the deployed instance of the on-demand agent the location from which to download the script. Furthermore, coordinator agent 192 assigns a name to the deployed instance of the on-demand agent, which is that determined at step 310 if there was already an instance of the on-demand agent executing, as determined at step 306.

At step 314, the newly deployed instance of the on-demand agent downloads the executable script from the location specified in the cloud-to-agent message. Specifically, the on-demand agent makes an HTTP request to the location included in the cloud-to-agent message. Script service 118 then retrieves the script from a database managed by script service 118 and transmits the executable script to the instance of the on-demand agent.

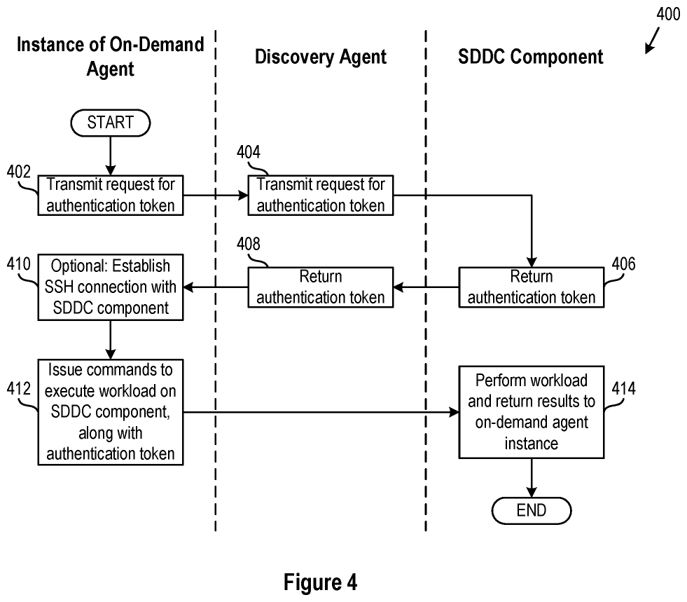

At step 316, based on the executable script, the instance of the on-demand agent issues commands to one of SDDCs 120 to execute a workload on a management appliance therein. For example, the workload may include remediation operations or mutation operations, as discussed above. Additionally, upon completion of the transmitted commands, the instance of the on-demand agent detects results from SDDC 120 such as the running state of the management appliance no longer being in drift or a virtual inventory of virtual objects deployed in SDDC 120 being successfully updated. The issuing of commands and detecting of results is discussed further below in conjunction with FIG. 4.

At step 318, the instance of the on-demand agent transmits the detected results to coordinator agent 192. At step 320, coordinator agent 192 transmits a message to message broker agent 160, including the results and the name of the corresponding cloud service of cloud platform 110 as the intended recipient. At step 322, in response to the completion of the workload, coordinator agent 192 deletes the instance of the on-demand agent. After step 322, method 300 ends, and message broker agent 160 transmits the message to message broker service 116 in an exchange of messages, message broker service 116 then forwarding the message to the corresponding cloud service.

FIG. 4 is a flow diagram of steps performed by an instance of an on-demand agent and one of discovery agents 180 to carry out a method 400 of issuing commands to an SDDC component and detecting results of the performance of a workload, according to an embodiment. At step 402, the instance of the on-demand agent transmits a request to discovery agent 180 for an authentication token. At step 404, discovery agent 180 transmits a request to the SDDC component for the authentication token. At step 406, the SDDC component returns the requested authentication token to discovery agent 180. At step 408, discovery agent 180 returns the authentication token to the instance of the on-demand agent.

At step 410, which is an optional step, the instance of the on-demand agent establishes a secure shell (SSH) connection with the SDDC component. At step 412, the instance of the on-demand agent issues commands to execute a workload on the SDDC component, along with the authentication token. The commands may be issued according to an API of the management appliance. The commands may also optionally be issued via an SSH connection established at step 410. At step 414, upon verifying the authentication token, the SDDC component performs the workload. The SDDC component then transmits the results of performing the workload to the instance of the on-demand agent. After step 414, method 400 ends.

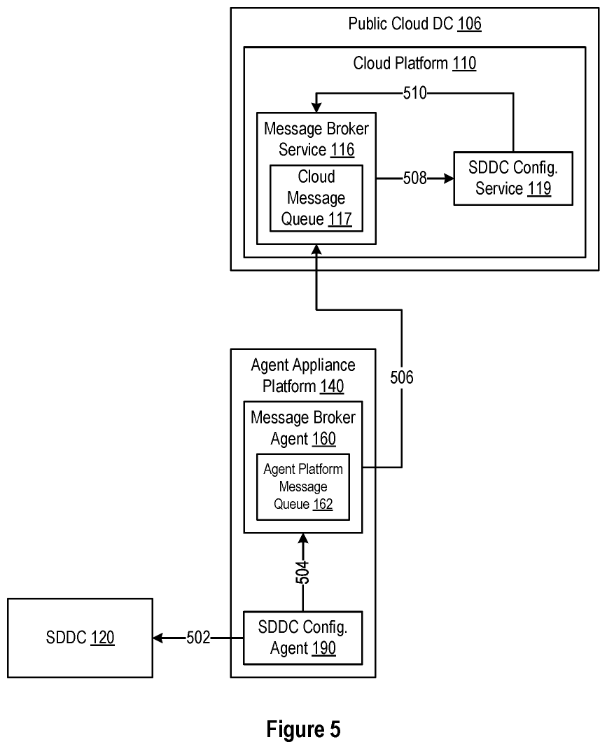

FIG. 5 is a sequence diagram illustrating an example of SDDC configuration agent 190 generating an alert indicating that one of SDDCs 120 requires remediation, and in response, SDDC configuration service 119 generating a message to initiate remediation. At step 502, SDDC configuration agent 190 determines that the running state of SDDC 120 has drifted from its desired state. SDDC configuration agent 190 makes this determination by comparing current configurations of management appliances of SDDC 120 to configurations of a desired state document and discovering a discrepancy for one of the management appliances.

At step 504, SDDC configuration agent 190 generates an alert that SDDC 120 requires remediation and transmits the alert to message broker agent 160, which queues the alert in agent platform message queue 162. The alert specifies SDDC configuration service 119 as the intended recipient. At step 506, message broker agent 160 initiates an exchange of messages with message broker service 116, transmitting the alert to message broker service 116. Message broker agent 160 also transmits an access token acquired from identity agent 170. Additional details on the steps of determining drift and generating the alert are described in U.S. patent application Ser. No. 17/665,602, filed Feb. 7, 2022, the entire contents of which are incorporated by reference herein.

At step 508, message broker service 116 transmits the alert to SDDC configuration service 119. At step 510, SDDC configuration service 119 generates a message instructing the initiation of a workload to remediate SDDC 120 back to its corresponding desired state. The message includes a location from which to download an executable script from script service 118. SDDC configuration service 119 transmits the generated message to message broker service 116, which stores the message in cloud message queue 117 until message broker agent 160 initiates a message exchange to acquire the message and provide the message to coordinator agent 192, as discussed in steps 302-304 of FIG. 3. Coordinator agent 192 then deploys an instance of an on-demand agent to issue commands to execute a workload, as discussed above in conjunction with FIG. 3.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of executing a workload initiated from a cloud platform, in a software-defined data center (SDDC), wherein the cloud platform delivers cloud services to the SDDC, the method comprising:
deploying a first agent in an agent appliance platform that is connected to a management network of the SDDC, wherein the first agent is an agent of one of the cloud services and issues commands to execute the workload on the SDDC; and
upon completion of the workload, deleting the first agent from the agent appliance platform.

2. The method of claim 1, wherein the commands from the first agent are issued to a management appliance of the SDDC according to an application programming interface (API) of the management appliance.

3. The method of claim 1, wherein a secure shell (SSH) connection is established with a management appliance of the SDDC, and the commands are issued via the SSH connection.

4. The method of claim 1, further comprising:
after the deploying of the first agent in the agent appliance platform but before the deleting of the first agent, deploying another instance of the first agent in the agent appliance platform.

5. The method of claim 4, further comprising:
assigning different names to different instances of the first agent.

6. The method of claim 1, further comprising:
acquiring a message from a second agent deployed in the agent appliance platform, wherein the message is from said one of the cloud services and includes a location from which to download a script for executing the workload, and the second agent acquired the message by initiating an exchange of messages with another one of the cloud services of the cloud platform.

7. The method of claim 6, wherein the first agent is deployed based on contents of the message.

8. The method of claim 6, wherein a third agent deployed in the SDDC generates an alert for said one of the cloud services indicating that the SDDC requires remediation, and the message is generated by said one of the cloud services in response to the alert.

9. A non-transitory computer-readable medium comprising instructions that are executable in a computer system, wherein the instructions when executed cause the computer system to carry out a method of executing a workload initiated from a cloud platform, in a software-defined data center (SDDC), wherein the cloud platform delivers cloud services to the SDDC, the method comprising:
deploying a first agent in an agent appliance platform that is connected to a management network of the SDDC, wherein the first agent is an agent of one of the cloud services and issues commands to execute the workload on the SDDC; and
upon completion of the workload, deleting the first agent from the agent appliance platform.

10. The non-transitory computer-readable medium of claim 9, wherein the commands from the first agent are issued to a management appliance of the SDDC according to an application programming interface (API) of the management appliance.

11. The non-transitory computer-readable medium of claim 9, wherein a secure shell (SSH) connection is established with a management appliance of the SDDC, and the commands are issued via the SSH connection.

12. The non-transitory computer-readable medium of claim 9, the method further comprising:
after the deploying of the first agent in the agent appliance platform but before the deleting of the first agent, deploying another instance of the first agent in the agent appliance platform.

13. The non-transitory computer-readable medium of claim 12, the method further comprising:
assigning different names to different instances of the first agent.

14. The non-transitory computer-readable medium of claim 9, the method further comprising:
acquiring a message from a second agent deployed in the agent appliance platform, wherein the message is from said one of the cloud services and includes a location from which to download a script for executing the workload, and the second agent acquired the message by initiating an exchange of messages with another one of the cloud services of the cloud platform.

15. The non-transitory computer-readable medium of claim 14, wherein the first agent is deployed based on contents of the message.

16. The non-transitory computer-readable medium of claim 14, wherein a third agent deployed in the SDDC generates an alert for said one of the cloud services indicating that the SDDC requires remediation, and the message is generated by said one of the cloud services in response to the alert.

17. A computer system comprising a plurality of servers, the plurality of servers including an agent appliance platform connected to a management network of a software-defined data center (SDDC), and the agent appliance platform including a plurality of agents deployed thereon, wherein
the agents include a first agent that is configured to deploy a second agent in the agent appliance platform, the second agent being an agent of a cloud service of a cloud platform and issuing commands to execute a workload on the SDDC, and
upon completion of the workload, the first agent deletes the second agent from the agent appliance platform.

18. The computer system of claim 17, wherein the commands from the second agent are issued to a management appliance of the SDDC according to an application programming interface (API) of the management appliance.

19. The computer system of claim 17, wherein a secure shell (SSH) connection is established with a management appliance of the SDDC, and the commands are issued via the SSH connection.

20. The computer system of claim 17, wherein after the deploying of the second agent in the agent appliance platform but before the deleting of the second agent, the first agent deploys another instance of the second agent in the agent appliance platform.

21. The computer system of claim 20, wherein the first agent assigns different names to different instances of the first agent.

22. The computer system of claim 17, wherein the first agent acquires a message from a third agent deployed in the agent appliance platform, the message being from the cloud service and including a location from which to download a script for executing the workload, and the third agent acquired the message by initiating an exchange of messages with another cloud service of the cloud platform.

23. The computer system of claim 22, wherein the second agent is deployed based on contents of the message.

24. The computer system of claim 22, wherein a fourth agent deployed in the SDDC generates an alert for the cloud service indicating that the SDDC requires remediation, and the message is generated by the cloud service in response to the alert.
